(19) United States
(12) Patent Application Publication
(10) Pub. No.: US 2006/0144105 A1
(43) Pub. Date: Jul. 6, 2006

(54) Lock core preventable to be pried unlocked

(76) Inventor: Meng-Fu Chen, Taichung Hsien (TW)

Correspondence Address: Meng-Fu CHEN, P.O. BOX 90, Tainan City, 70499, TW

(21) Appl. No.: 11/166,131

(22) Filed: Jun. 27, 2005

(30) Foreign Application Priority Data
Dec. 31, 2004 (TW) 093141572

(51) Int. Cl. E05B 15/08

(52) U.S. Cl. 70/419; 70/453

(57) ABSTRACT

A lock core preventable to be pried unlocked includes a disguised lock core provided in front of a real lock core and bored with a key slot. When a burglar attempts to unlock the lock, he will insert a universal key into the key slot of the disguised lock core, trying to release the lock rod in the common lock core. Since the keyhole of the common lock core is not aligned to the key slot of the disguised lock core, the universal key can only be inserted in the key slot of the disguised lock core, impossible to reach in the keyhole of the real lock core. Thus, despise being turned around, the universal key can only make the disguised lock core rotate idly, with the real lock core still locked, having an excellent effect of anti-burglary.

### BACKGROUND OF THE INVENTION

1. Field of the Invention

This invention relates to a lock core preventable to be pried unlocked, particularly to one has a disguised lock core provided in front of a real lock core and bored with a key slot, with the common lock core hidden in the interior of a lock. When a burglar attempts to unlock the lock of this invention with a universal key, he will mistake the disguised lock core exposed outside for the real lock core and insert the universal key in the key slot of the disguised lock core, trying to release the lock rod in the common lock core. Since the keyhole of the real lock core is not aligned to the key slot of the disguised lock core; therefore, the universal key can only be inserted in the key slot of the disguised lock core, but cannot be inserted in the keyhole of the common lock core. Thus, in spite of being turned around, the universal key can only make the disguised lock core rotate idly with the real lock core still locked, having an excellent effect of anti-burglary.

2. Description of the Prior Art

A conventional lock core 11 is fitted in a cylinder 10 and bored with a keyhole 12 for a key to be inserted therein, as shown in FIG. 1. To unlock a lock, the key is inserted in the keyhole 12 of the lock core 11 to push and release the lock rod in the lock core 11 and turn around the lock core 11 and release other lock members to finish unlocking of the lock.

However, the conventional lock core 11 has its key hole 12 exposed out of the cylinder 10; therefore, a burglar can easily unlock the lock only by inserting a universal key in the key hole 12 to release the lock rod in the lock core 11, impossible to guard against burglary.

### SUMMARY OF THE INVENTION

The objective of the invention is to offer a lock core preventable to be pried unlocked, having an excellent effect of anti-burglary.

The feature of the invention is a disguised lock core provided in front of a common lock core and bored with a key slot.

### BRIEF DESCRIPTION OF DRAWINGS

This invention will be better understood by referring to the accompanying drawings, wherein:

FIG. 1 is a perspective view of a conventional lock core;

FIG. 2 is an exploded perspective view of a lock core preventable to be pried unlocked in the present invention;

FIG. 3 is a perspective view of the lock core preventable to be pried unlocked in the present invention;

FIG. 4 is a cross-sectional view of the lock core preventable to be pried unlocked in the present invention;

FIG. 5 is a side cross-sectional view of the lock core preventable to be pried unlocked in the present invention, showing that the key slot of a disguised lock core is aligned to the key hole of a real lock core;

FIG. 6 is a side cross-sectional view of the lock core preventable to be pried unlocked in the present invention, showing that the key slot of the disguised lock core is not aligned to the key hole of the real lock core; and,

FIG. 7 is a cross-sectional view of the lock core preventable to be pried unlocked in the present invention, showing that a universal key can only be inserted in the key slot of the disguised lock core but cannot inserted in the key hole of the real lock core.

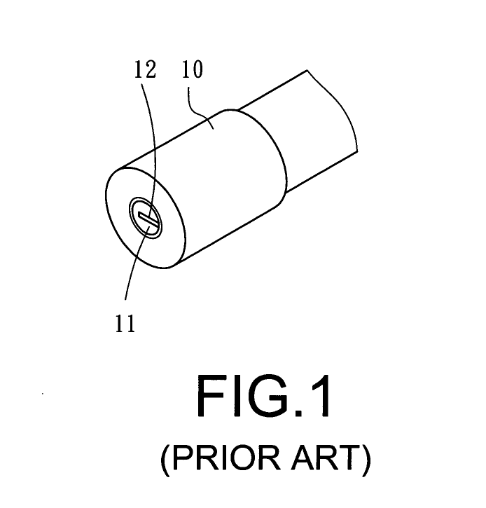

### DETAILED DESCRIPTION OF THE PREFERRED EMBODIMENT

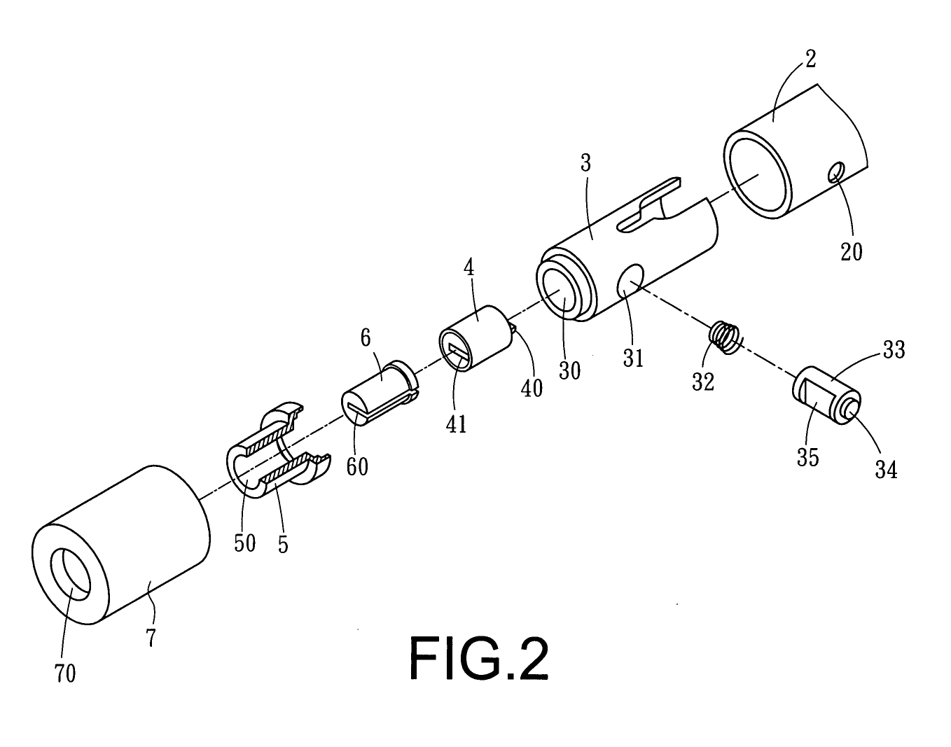

A preferred embodiment of a lock core preventable to be pried unlocked in the present invention, as shown in FIG. 2, includes a cylinder 2, a locking member 3, a real lock core 4, a press member 5, a disguised lock core 6 and a sleeve 7 combined together.

The cylinder 2 has its sidewall bored with an engage hole 20.

The locking member 3 received in the cylinder 2 has its interior formed with an accommodating chamber 30 and its sidewall bored with a recessed chamber 31 communicating with the accommodating chamber 30, A spring 32 and a deadbolt 33 are received in the recessed chamber 31 of the locking member 3. The deadbolt 33 has its outer end provided with a projection 34 and its sidewall bored with an engage groove 35.

The real lock core 4 received in the accommodating chamber 30 of the locking member 3 has one end provided with a rotary member 40 and the other end bored with a key hole 41.

The press member 5 fixed on one end of the locking member 3 is bored with an insert hollow 50 in the interior.

The disguised lock core 6 is received in the insert hollow 50 of the press member 5 and bored with a key slot 60.

The sleeve 7 is assembled on one end of the cylinder 2 and has its interior formed with an insert hollow 70.

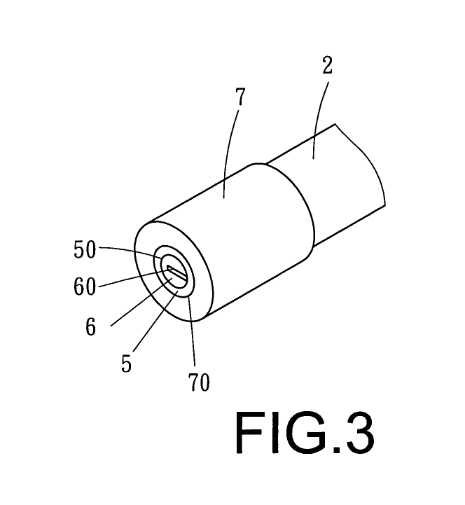

In assembling, as shown in FIGS. 2, 3 and 4, firstly, the spring 32 and the deadbolt 33 are fitted in the recessed chamber 31 of the locking member 3, and the real lock core 4 is received in the accommodating chamber 30 of the locking member 3, having its rotary member 40 positioned in the engage groove 35 of the deadbolt 33. Next, the disguised lock core 6 is received in the insert hollow 50 of the press member 5 and then the press member 5 together with the disguised lock core 6 is assembled on one end of the locking member 3. Subsequently, the locking member 3 is fitted in the interior of the cylinder 2, letting the projection 34 of the deadbolt 33 engaged in the engage hole 20 of the cylinder 2. Lastly, the sleeve 7 is assembled on one end of the cylinder 2 to finish assembly of a lock core preventable to be pried unlocked.

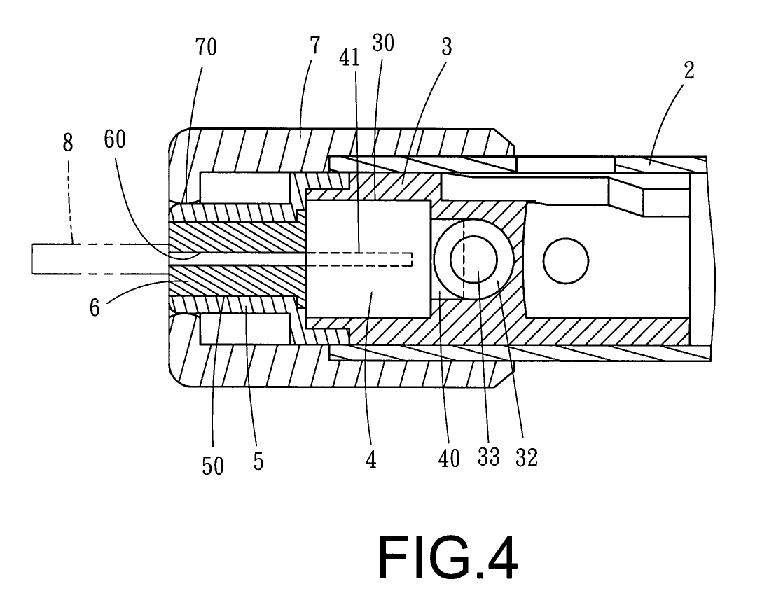

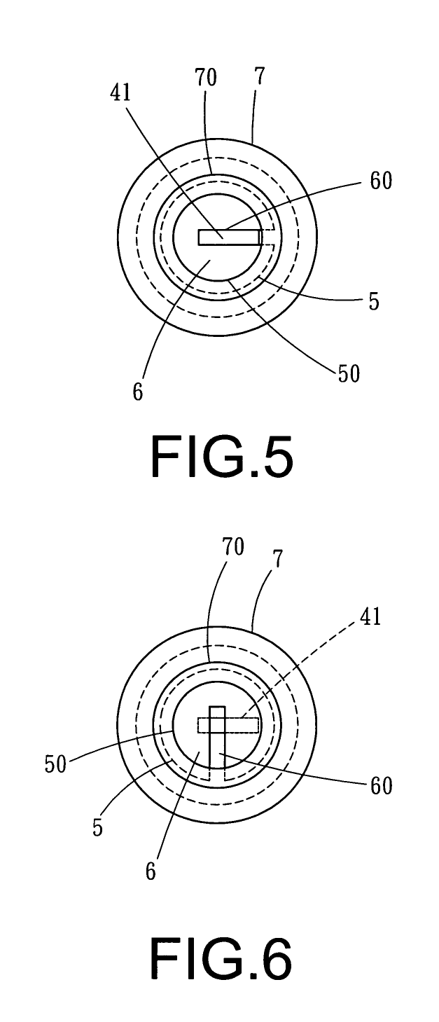

To unlock the lock of this invention, as shown in FIGS. 4, 5 and 6, a key 8 matching with the lock is first inserted in the key slot 60 of the disguised lock core 6 and turned around to actuate the disguised lock core 6 to rotate for 90 degrees to align its key slot 60 to the key hole 41 of the common lock core 4, as shown in FIG. 5. Afterward, the key 8 is continuously inserted in the key hole 41 of the common lock core 4 to release the lock rod in the real lock core 4 and then turned around to actuate the common lock core 4 to rotate and have its rotary member 40 actuating the deadbolt 33 to move inward and disengage from the engage hole 20 of the cylinder 2 to finish unlocking of the lock.

On the other hand, after the lock is locked, the key 8 is pulled outward a little to let its front end moved out of the key hole 41 of the lock core 4, and then the key 8 is turned around to actuate the disguised lock core 6 to rotate for 90 degrees to let its key slot 60 no longer aligned to the key hole 41 of the lock core 4, as shown in FIG. 6, thus finishing locking of the lock.

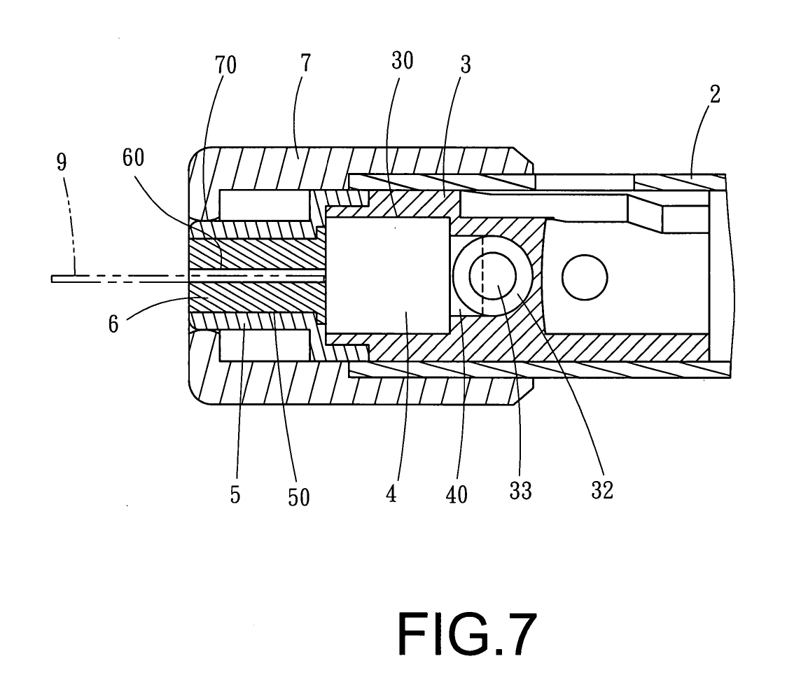

As can be noted from the above description, the disguised lock core 6 is fitted in the press member 5 and the real lock core 4 is hidden in the interior of the lock; therefore, when a burglar attempts to unlock the lock of this invention with a universal key 9, he may take the disguised lock core 6 exposed outside to be the real lock core 4 and insert the universal key 9 into the key slot 60 of the disguised lock core 6, trying to unlock the real lock core 4 but in vain. This is because the key hole 41 of the lock core 4 positioned in the interior of the lock is not aligned to the key slot 60 of the disguised lock core 6; therefore, the universal key 9 can only be inserted in the key slot 60 of the disguised lock core 6, impossible to reach in the key hole 41 of the real lock core 4, as shown in FIG. 7. Thus, in spite of being turned around, the universal key 9 can only make the disguised lock core 6 rotate idly, with the real lock core 4 still locked, obtaining an excellent effect of anti-burglary.

While the preferred embodiment of the invention has been described above, it will be recognized and understood that various modifications may be made therein and the appended claims are intended to cover all such modifications that may fall within the spirit and scope of the invention.

1. A lock core preventable to be pried unlocked comprising
a cylinder, said cylinder having one side wall bored with an engage hole,
a locking member received in the interior of said cylinder, said locking member having its interior formed with an accommodating chamber, said locking member having its sidewall bored with a recessed chamber communicating with said accommodating chamber, a spring and a deadbolt fitted in said recessed chamber of said locking member, said deadbolt having its outer end provided with a projection, said deadbolt having its sidewall bored with an engage groove,
a real lock core received in said accommodating chamber of said locking member, said real lock core having one end provided with a rotary member, said rotary member engaged in said engage groove of said deadbolt; said rotary member being a flat sheet, said real lock core having the other end bored with a key hole,
a press member fixed on one end of said locking member, said press member formed with an insert hollow in the interior, a sleeve assembled on one end of said cylinder, said sleeve 2 bored with an insert interior hollow; and,
a disguised lock core provided in front of said real lock core, said disguised lock core bored with a key slot not aligned to said key hole of said real lock core; and
wherein only one spring 32 and one deadbolt is used;
wherein in assembly, the spring is located at near a center of the locking member and said deadbolt is near a wall of said locking member; one end of the spring resists against said rotary member.
